(19) United States
(12) Patent Application Publication
(10) Pub. No.: US 2024/0044363 A1
(43) Pub. Date: Feb. 8, 2024

(54) SLIDING STRUT BEARING WITH POLYGONAL ANNULAR THRUST DISK

(71) Applicant: Schaeffler Technologies AG & Co. KG, Herzogenaurach (DE)

(72) Inventor: Kleberson Sierra, Sorocaba (BR)

(73) Assignee: Schaeffler Technologies AG & Co. KG, Herzogenaurach (DE)

(21) Appl. No.: 17/879,854

(22) Filed: Aug. 3, 2022

(51) Int. Cl. F16C 17/04

(52) U.S. Cl. CPC F16C 17/04; F16C 2326/05; B60G 15/068

(57) ABSTRACT

A strut bearing includes an upper case, a lower case, and a polygonal annular thrust bearing disk disposed axially between the upper case and the lower case. In some example embodiment, the polygonal annular thrust bearing disk has a first contact face and a second contact face in contact with the upper case, and a third contact face and a fourth contact face in contact with the lower case. In an example embodiment, the upper case has a first raceway surface in contact with the first contact face and a second raceway surface in contact with the second contact face, and the lower case has a third raceway surface in contact with the third contact face and a fourth raceway surface in contact with the fourth contact face.

### TECHNICAL FIELD

The present disclosure relates generally to a strut bearing, and more specifically to a sliding strut bearing with a polygonal annular thrust disk.

### BACKGROUND

Strut bearings are known. One example is shown and described in JP2008175349 titled STRUT BEARING to Tomomasa.

### SUMMARY

Example embodiments broadly comprise a strut bearing including an upper case, a lower case, and a polygonal annular thrust bearing disk disposed axially between the upper case and the lower case. In some example embodiment, the polygonal annular thrust bearing disk has a first contact face and a second contact face in contact with the upper case, and a third contact face and a fourth contact face in contact with the lower case. In an example embodiment, the upper case has a first raceway surface in contact with the first contact face and a second raceway surface in contact with the second contact face, and the lower case has a third raceway surface in contact with the third contact face and a fourth raceway surface in contact with the fourth contact face.

In some example embodiments, the first contact face is a first inclined surface, the second contact face is a second inclined surface, and the first inclined surface and the second inclined surface are arranged with a first obtuse angle therebetween. In an example embodiment, the polygonal annular thrust bearing disk also includes a first annular surface connecting the first contact face to the second contact face. In some example embodiments, the third contact face is a third inclined surface, the fourth contact face is a fourth inclined surface, and the third inclined surface and the fourth inclined surface are arranged with a second obtuse angle therebetween. In an example embodiment, the polygonal annular thrust bearing disk further comprises a second annular surface connecting the third contact face to the fourth contact face.

In some example embodiments, the upper case has a first cylindrical ring radially inside of the polygonal annular thrust bearing disk and a second cylindrical ring radially outside of the polygonal annular thrust bearing disk. In an example embodiment, the lower case has a third cylindrical ring radially inside of the first cylindrical ring and a fourth cylindrical ring radially outside of the second cylindrical ring. In an example embodiment, a one of the upper case or the lower case has a fifth cylindrical ring with a radially outwardly extending protrusion and the other of the upper case or the lower case has a sixth cylindrical ring with a radially inwardly extending protrusion arranged to snap together with the radially outwardly extending protrusion to retain the upper case and the lower case together.

In an example embodiment, the lower case has a stepped lower surface arranged for receiving a coil spring. In an example embodiment, the polygonal annular thrust bearing disk is an irregular octagon when viewed in cross-section. In an example embodiment, the upper case, the lower case, and the polygonal annular thrust bearing disk are all formed from a thermoplastic material. In an example embodiment, the polygonal annular thrust bearing disk is lubricated with a lubricating grease for smooth, low friction sliding against the upper case and the lower case.

Other example aspects broadly comprise a strut assembly including a top mount arranged for fixing to a body of a motor vehicle, a coil spring, and the strut bearing disposed between the top mount and the coil spring. In an example embodiment, the lower case has a stepped lower surface and the coil spring is supported on the stepped lower surface. In some example embodiments, the strut assembly also includes a shock absorber, and the shock absorber has a shaft that extends through the top mount, the coil spring and the strut bearing. In an example embodiment, the shock absorber has an annular protrusion and the coil spring is supported on the annular protrusion.

### BRIEF DESCRIPTION OF THE DRAWINGS

FIG. 1 illustrates a cross-sectional view of a strut assembly for a motor vehicle.

FIG. 2 illustrates a cross-sectional view of a strut bearing according to an example aspect of the present disclosure.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

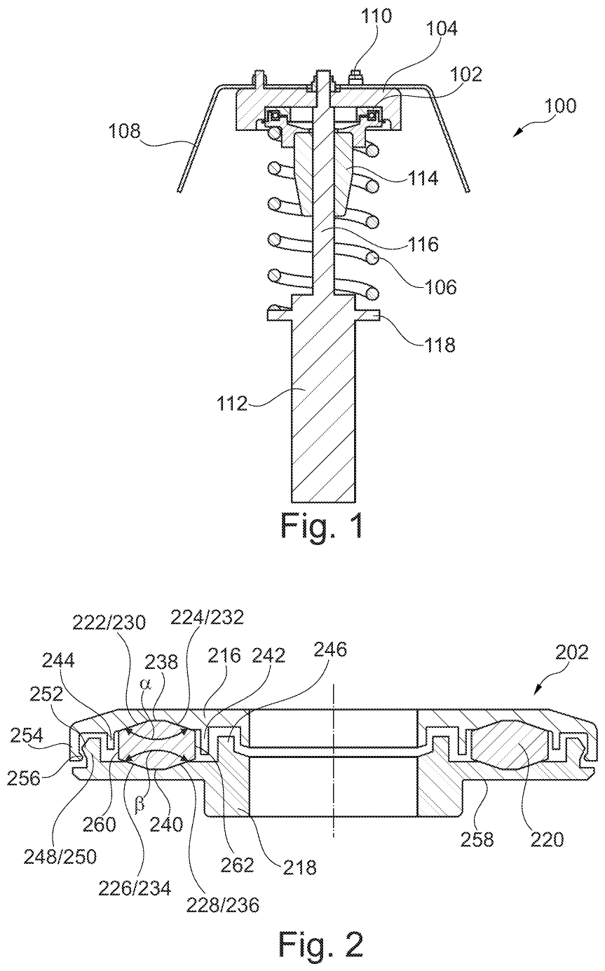

The following description is made with reference to FIG. 1. FIG. 1 illustrates a cross-sectional view of strut assembly 100 for a motor vehicle. Strut assembly 100 may be part of a McPherson suspension system as is known in the art. Strut assembly 100 includes strut bearing 102 installed between top mount 104 and coil spring 106, helping to position the spring. The top mount is fixed to body 108 of the motor vehicle at fasteners 110. Strut bearing 102 allows low friction rotation of shock absorber 112 during steering using ball or needle roller elements, or a synthetic resin thrust washer, for example. That is, because the bearing provides a low friction connection between the body and the spring, the shock absorber (and associated wheel, not shown), being supported on the spring, can be turned with less effort. In the embodiment shown, the strut bearing also supports bump stop 114, though this is an optional configuration.

The following description is made with reference to FIG. 2. FIG. 2 illustrates a cross-sectional view of strut bearing 202 according to an example aspect of the present disclosure. Strut bearing 202 includes upper case 216, lower case 218, and a polygonal annular thrust bearing disk 220 disposed axially between the upper case and the lower case. The polygonal annular thrust bearing disk has contact faces 222 and 224 in contact with the upper case, and contact face 226 and 228 in contact with the lower case. The upper case includes raceway surfaces 230 and 232 in contact with contact faces 222 and 224, respectively, and the lower case includes raceway surfaces 234 and 236 in contact with contact faces 226 and 228, respectively. The upper case, the lower case, and the polygonal annular thrust bearing disk are all formed from a thermoplastic material. Thermoplastic is relatively inexpensive and provides a smooth sliding surface with minimal friction between the mating components.

As can be seen in FIG. 2, for example, contact faces 222 and 224 are respective inclined surfaces arranged with obtuse angle α therebetween. Similarly, contact faces 226 and 228 are respective inclined surfaces arranged with obtuse angle β therebetween. Polygonal annular thrust bearing disk 220 also includes annular surface 238 connecting contact faces 222 and 224 and annular surface 240 connecting contact faces 226 and 228.

Upper case 216 includes cylindrical ring 242 radially inside of the polygonal annular thrust bearing disk, and cylindrical ring 244 radially outside of the polygonal annular thrust bearing disk. Similarly, lower case 218 includes cylindrical ring 246 radially inside of cylindrical ring 242 and cylindrical ring 248 radially outside of cylindrical ring 244. The polygonal annular thrust bearing disk is lubricated with a lubricating grease for smooth, low friction sliding against the upper case and the lower case, and rings 242, 244, 246 and 248 may form a labyrinth type of seal arrangement for retaining the lubricating grease, for example.

Lower case 218 includes cylindrical ring 250 with a radially outwardly extending protrusion 252 and upper case 216 includes cylindrical ring 254 with radially inwardly extending protrusion 256 arranged to snap together with the radially outwardly extending protrusion to retain the upper case and the lower case together. Although the radially outward protrusion is shown on the lower case and the radially inward protrusion is shown on the upper case, other embodiments (not shown) may include the two reversed so that the outward protrusion is on the upper case and the inward protrusion is on the bottom case, for example. The lower case includes stepped lower surface 258 arranged for receiving a coil spring as described in more detail below.

As can be seen in FIG. 2, for example, the polygonal annular thrust bearing disk is an irregular octagon when viewed in cross-section. As opposed to a regular octagon having all sides and angles of the same measure, an irregular octagon has at least one unequal side length and/or angle. As shown in FIG. 2, faces 222, 224, 226 and 228 have equal lengths, and surfaces 238 and 240 have equal lengths. Also, the angle between face 222 and surface 238 is equal to the angle between face 224 and surface 238, which is also equal to the angle between face 226 and face 240 and the angle between face 228 and surface 240. Side surfaces 260 and 262 are also equal in length and an angle between each side surface and a respective contact face is equal. It should be noted that other embodiments are possible, however. For example, lengths of surfaces 222, 224, 226 and 228 may be unequal and optimized for a particular application. Similarly, angles between the faces and surfaces may be unequal for similar design considerations.

As discussed above, with regards to strut bearing 102, strut bearing 202 may be incorporated into a strut assembly with top mount 104 arranged for fixing to body 108 of a motor vehicle (not shown), coil spring 106, and strut bearing 202 disposed between the top mount and the coil spring. Lower case 218 includes stepped lower surface 258 and the coil spring is supported on the stepped lower surface. The strut assembly also includes shock absorber 112 with shaft 116 that extends through the top mount, the coil spring and the strut bearing. Shock absorber 112 also includes annular protrusion 118 and the coil spring is supported on the annular protrusion.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### REFERENCE NUMERALS

100 Strut assembly
102 Strut bearing
104 Top mount
106 Coil spring
108 Motor vehicle body
110 Fasteners
112 Shock absorber
114 Bump stop
116 Shaft
118 Annular protrusion
202 Strut bearing
216 Upper case
218 Lower case
220 Polygonal annular thrust bearing disk
222 Contact face (first)
224 Contact face (second)
226 Contact face (third)
228 Contact face (fourth)
230 Raceway surface (first)
232 Raceway surface (second)
234 Raceway surface (third)
236 Raceway surface (fourth)
238 Annular surface (first)
240 Annular surface (second)
242 Cylindrical ring (first)
244 Cylindrical ring (second)
246 Cylindrical ring (third)
248 Cylindrical ring (fourth)
250 Cylindrical ring (fifth)
252 Radially outwardly extending protrusion
254 Cylindrical ring (sixth)
256 Radially inwardly extending protrusion
258 Stepped lower surface
260 Side surface (first)
262 Side surface (second)
α Obtuse angle (first)
β Obtuse angle (second)

What is claimed is:

1. A strut bearing, comprising:
an upper case;
a lower case; and
a polygonal annular thrust bearing disk disposed axially between the upper case and the lower case.

2. The strut bearing of claim 1 wherein the polygonal annular thrust bearing disk comprises:
a first contact face and a second contact face in contact with the upper case; and
a third contact face and a fourth contact face in contact with the lower case.

3. The strut bearing of claim 2 wherein:
the upper case comprises a first raceway surface in contact with the first contact face and a second raceway surface in contact with the second contact face; and
the lower case comprises a third raceway surface in contact with the third contact face and a fourth raceway surface in contact with the fourth contact face.

4. The strut bearing of claim 2 wherein:
the first contact face is a first inclined surface;
the second contact face is a second inclined surface; and
the first inclined surface and the second inclined surface are arranged with a first obtuse angle therebetween.

5. The strut bearing of claim 4 wherein the polygonal annular thrust bearing disk further comprises a first annular surface connecting the first contact face to the second contact face.

6. The strut bearing of claim 2 wherein:
the third contact face is a third inclined surface;
the fourth contact face is a fourth inclined surface; and
the third inclined surface and the fourth inclined surface are arranged with a second obtuse angle therebetween.

7. The strut bearing of claim 6 wherein the polygonal annular thrust bearing disk further comprises a second annular surface connecting the third contact face to the fourth contact face.

8. The strut bearing of claim 1 wherein the upper case comprises:
a first cylindrical ring radially inside of the polygonal annular thrust bearing disk; and
a second cylindrical ring radially outside of the polygonal annular thrust bearing disk.

9. The strut bearing of claim 8 wherein the lower case comprises:
a third cylindrical ring radially inside of the first cylindrical ring; and
a fourth cylindrical ring radially outside of the second cylindrical ring.

10. The strut bearing of claim 1 wherein:
a one of the upper case or the lower case comprises a fifth cylindrical ring with a radially outwardly extending protrusion; and
the other of the upper case or the lower case comprises a sixth cylindrical ring with a radially inwardly extending protrusion arranged to snap together with the radially outwardly extending protrusion to retain the upper case and the lower case together.

11. The strut bearing of claim 1 wherein the lower case comprises a stepped lower surface arranged for receiving a coil spring.

12. The strut bearing of claim 1 wherein the polygonal annular thrust bearing disk is an irregular octagon when viewed in cross-section.

13. The strut bearing of claim 1 wherein the upper case, the lower case, and the polygonal annular thrust bearing disk are all formed from a thermoplastic material.

14. The strut bearing of claim 1 wherein the polygonal annular thrust bearing disk is lubricated with a lubricating grease for smooth, low friction sliding against the upper case and the lower case.

15. A strut assembly comprising:
a top mount arranged for fixing to a body of a motor vehicle;
a coil spring; and
the strut bearing of claim 1 disposed between the top mount and the coil spring.

16. The strut assembly of claim 15 wherein:
the lower case comprises a stepped lower surface; and
the coil spring is supported on the stepped lower surface.

17. The strut assembly of claim 15 further comprising a shock absorber, the shock absorber comprising a shaft that extends through the top mount, the coil spring and the strut bearing.

18. The strut assembly of claim 17 wherein:
the shock absorber comprises an annular protrusion; and
the coil spring is supported on the annular protrusion.
